(19) United States
(12) Patent Application Publication
(10) Pub. No.: US 2011/0009306 A1
(43) Pub. Date: Jan. 13, 2011

(54) COMPOSITIONS CONTAINING BENEFIT AGENT DELIVERY PARTICLES

(76) Inventors: Michelle Meek, Tyne and Wear (GB); Philip Frank Souter, Northumberland (GB); Susana Fernandez Prieto, Benicarlo (ES); Johan Smets, Lubbeek (BE); Mohan Gopalkrishna Kulkarni, Pune (IN); Parshuram Gajanan Shukla, Pune (IN); Aruna Narayan Bote, Pune (IN); Arun Savalaram Jadhav, Pune (IN)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/832,342

(22) Filed: Jul. 8, 2010

Related U.S. Application Data
(60) Provisional application No. 61/224,497, filed on Jul. 10, 2009.

(51) Int. Cl. C11D 17/00; C11D 7/60; C08L 73/00; C11D 7/42; C08L 89/00

(52) U.S. Cl. 510/320; 510/349; 510/516; 524/600; 524/17

(57) ABSTRACT

The present disclosure relates to benefit agent delivery particles containing at least one benefit agent and at least one cellulosic polymer. The disclosure further relates to fabric care compositions containing benefit agent delivery particles and processes for making and using such compositions. The disclosure further relates to methods of imparting a benefit delivery capability to a fabric care composition.

### CROSS REFERENCE TO RELATED APPLICATIONS

This application claims benefit of and priority to U.S. Provisional Application Ser. No. 61/224,497 filed Jul. 10, 2009.

### FIELD OF INVENTION

The present disclosure relates to benefit agent delivery particles, fabric care compositions comprising such benefit agent delivery particles, and processes for making and using such benefit agent delivery particles and compositions.

### BACKGROUND OF THE INVENTION

Benefit agents, such as enzymes, hueing dyes, perfumes, perfume delivery compositions, bleaching agents and polymers, are expensive and can be difficult to formulate, particularly into fabric care compositions, due to their incompatibility with the softening active, with other optional ingredients in the composition and/or low pH of the fabric care compositions. Further, because such compositions must often be stored for long periods of time, the overall care performance of the composition may be compromised as a result of formulation degradation during storage or the interaction of benefit agents with other formulation ingredients.

As benefit agents tend to be expensive, there is a desire to maximize their effectiveness. Benefit agent effectiveness may be improved by segregating the product's benefit agent from other product ingredients, for example by encapsulating the benefit agent. Segregation may impart many benefits, including improved product stability during storage, enhanced benefit delivery, and/or delivery of a benefit using lower levels of benefit agent. This provides the formulator and consumer with a sustainability advantage as material resources are used more effectively. Unfortunately, capsules comprising a benefit agent may not release the benefit agent at the right rate or time as their benefit release mechanisms, including diffusion and/or capsule rupture rate, may be variable.

Thus, there is a need for compositions wherein incompatible benefit agents can be stored without the detrimental effect of degradation of one or more ingredients during storage. There is a further need for compositions wherein the benefit agent can be stably stored within the composition but which can be effectively released in use. The disclosed encapsulation systems and/or compositions minimize or eliminate one or more of the aforementioned drawbacks.

### SUMMARY OF THE INVENTION

The present disclosure relates to benefit agent delivery particles, fabric care compositions comprising such benefit agent delivery particles, and processes for making and using such benefit agent delivery particles and compositions. Such compositions may comprise liquid compositions such as liquid fabric conditioner products.

In one embodiment, the present disclosure provides a fabric care composition comprising a benefit agent delivery particle comprising a benefit agent and a cellulosic polymer selected from the group consisting of hydroxypropyl methylcellulose phthalate, cellulose acetate phthalate, and mixtures thereof; and one or more adjunct materials selected from the group comprising fabric softener actives, suds suppressors, soil release agents, soil suspension polymers, perfumes, pro-perfumes, perfume micro-capsules, malodor control agents, hueing agents and combinations thereof.

In another embodiment, the present disclosure provides a method of imparting a benefit delivery capability to a fabric care composition comprising combining a particle comprising a benefit agent and a polymer selected from the group consisting of hydroxypropyl methylcellulose phthalate, cellulose acetate phthalate, and mixtures thereof with the fabric care composition

### DETAILED DESCRIPTION OF THE INVENTION

### Definitions

As used herein, the phrase “benefit agent delivery particle” is intended to refer to encapsulates and/or microcapsules and/or aggregates and/or particles comprising one or more benefit agents and one or more cellulosic polymer as described herein.

As used herein, the term “fabric care composition” includes, unless otherwise indicated, fabric softening compositions, fabric conditioning compositions, fabric enhancing compositions, fabric freshening compositions and combinations thereof.

As used herein, the articles such as “a” and “an” when used in a claim, are understood to mean one or more of what is claimed or described.

As used herein, the terms “include,” “includes,” and “including” are meant to be non-limiting. As used herein, the term “liquid,” as applied to the compositions herein, is intended to refer to compositions having a viscosity of from about 5 centipoises to about 50,000 centipoises and includes liquid, gel and paste product forms.

The test methods disclosed in the Test Methods Section of the present application should be used to determine the respective values of the parameters of Applicants' inventions. Unless otherwise noted, the enzymes disclosed herein are expressed in terms of active protein level and are exclusive of impurities, for example, residual solvents or by-products, which may be present in commercially available sources.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Compositions

Fabric Care compositions containing a benefit agent delivery particle are disclosed. The benefit agent delivery particles may comprise at least one cellulosic polymer selected from the group consisting of hydroxypropyl methylcellulose phthalate (HPMCP), cellulose acetate phthalate (CAP), and mixtures thereof, and a benefit agent. The polymers may be those commercially available under the trade names NF Hypromellose Phthalate (HPMCP) (Shin-Etsu), cellulose ester NF or cellulose cellacefate NF (CAP) from G.M. Chemie Pvt Ltd, Mumbai, 400705, India and Eastman Chemical Company, Kingsport, USA. The benefit agent may comprise a material selected from the group comprising enzymes, hueing dyes, metal catalysts, perfumes, pro-perfumes, biopolymers, antimicrobial agents, malodour protection agents, chelating agents, and mixtures thereof. The benefit provided by the benefit agent delivery particle may include improved softness, improved freshness, improved whiteness, bleaching, longer lasting freshness, skin care and fabric hueing.

In one aspect, the one or more benefit is an enzyme. The benefit agent may comprise hemicellulases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, oxidoreductases, dehydrogenases, xyloglucanases, amylases, cellulases, and mixtures thereof.

In one embodiment, the benefit agent may comprise a lipase or a protease. In one aspect, the enzyme may comprise a serine protease, including neutral or alkaline microbial serine proteases. In one aspect, said neutral or alkaline serine proteases may comprise subtilisins (EC 3.4.21.62) derived from Bacillus, such as Bacillus lentus, B. alkalophilus, B. subtilis, B. amyloliquefaciens, Bacillus pumilus and Bacillus gibsonii and genetically modified variants thereof possessing at least about 90%, at least about 95%, at least about 98%, or at least about 99%, or 100% identity with said neutral or alkaline serine proteases. As used herein, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277; http://emboss.org), version 3.0.0 or later. The optional parameters used are gap open penalty of 10, gap extension penalty of 0.5, and the EBLOSUM62 (EMBOSS version of BLOSUM62) substitution matrix. The output of Needle labelled “longest identity” (obtained using the—no brief option) is used as the percent identity and is calculated as follows:

(Identical Residues×100)/(Length of Alignment−Total Number of Gaps in Alignment)

In one aspect, the protease may be a variant of the subtilisin BPN′ wild-type enzyme derived from Bacillus amyloliquefaciens that contains the Y217L mutation. The subtilisin BPN′ wild-type enzyme sequence is the 275 amino acids (amino acids 108-382) of the Swissprot accession no. P00782 (derived from Bacillus amyloliquefaciens).

In one aspect, the enzyme may comprise a metalloprotease derived from Bacillus amyloliquefaciens and genetically modified variants thereof possessing at least about 90%, at least about 95%, at least about 98%, or at least about 99%, or 100% identity with said metalloprotease.

In one aspect, the enzyme may comprise an α-amylase. The α-amylase may comprise any from the EC classification 3.2.1.1. The α-amylase may comprise low temperature amylases, or chemically or genetically modified mutants (variants) of low temperature amylases include. Examples include alkaline amylases possessing at least about 90%, at least about 95%, at least about 98%, or at least about 99%, or 100% identity with those derived from Bacillus sp. NCIB 12289, NCIB 12512, NCIB 12513, DSM 9375 (U.S. Pat. No. 7,153,818) DSM 12368, DSMZ no. 12649, KSM AP1378 (US 2008/0050807 A1), KSM K36 or KSM K38 (US 2002/0197698 A1).

In one aspect, the enzyme may comprise a lipase having E.C. classification 3.1.1.3, as defined by EC classification, IUPAC-IUBMB and genetically modified variants thereof possessing at least about 90%, at least about 95%, at least about 98%, or at least about 99%, or 100% identity with said lipase. In one aspect, said lipase and variants thereof are derived from the wild-type Humicola Lanuginosa. In one aspect, the lipase may be a variant of the wild-type lipase from Thermomyces lanuginosus comprising the T231R and N233R mutations. The wild-type sequence is the 269 amino acids (amino acids 23-291) of the Swissprot accession number Swiss-Prot 059952 (derived from Thermomyces lanuginosus (Humicola lanuginosa)).

In one aspect the enzyme may comprise a xyloglucanase belonging to family 44 of glycosyl hydrolases.

In one aspect, the enzyme may comprise a cutinase as defined by E.C. Class 3.1.1.73. The enzyme may have at least about 90% or about 95%, or about 98% identity with a wild-type from one of Fusarium solani, Pseudomonas Mendocina or Humicola Insolens.

In a further aspect, the enzyme may comprise cellobiose dehydrogenase.

In one aspect, the benefit agent may comprise a bleach or bleach catalyst such as preformed peracids, bleach activators, catalytic metal complexes, non-metal bleach catalyst and mixtures thereof. In one aspect, preformed peracids include percarboxylic acids and salts, percarbonic acids and salts, perimidic acids and salts, peroxymonosulfuric acids and salts, (for example, Oxone®), and mixtures thereof.

In one aspect the benefit agent may comprise a catalytic metal complex. The transition-metal bleach catalyst may comprise, for example, manganese, iron and chromium. In one aspect, the ligand may comprise an ultra-rigid cross-bridged ligand such as 5,12-diethyl-1,5,8,12-tetraazabicyclo[6.6.2]hexa-decane. Suitable transition metal ligands are readily prepared by known procedures, for example, as taught in WO00/32601, and U.S. Pat. No. 6,225,464. Suitable non-metal bleach catalysts and appropriate levels of such catalysts are disclosed in U.S. Pat. No. 7,169,744 B2 and USPA 2006/0287210 A1. Suitable metal catalysts include dichloro-1,4-diethyl-1,4,8,11-tetraaazabicyclo [6.6.2]hexadecane manganese(II); dichloro-1,4-dimethyl-1,4,8,11-tetraaazabicyclo[6.6.2]hexadecane manganese(II), and mixtures thereof.

In one aspect, the benefit agent may comprise a perfume, a pro-perfume, a perfume delivery composition, or mixtures thereof. In one aspect, the benefit agent contains at least one perfume ingredient comprising a melamine formaldehyde polymer that encapsulates the at least one perfume ingredient.

In one aspect, the benefit agent may comprise a hueing dye such as those disclosed in USPA 2007/0129150 A1 and USPA 2008/0177089 A1, a dye, dye-clay conjugates, and/or pigments. Suitable hueing dyes include: (a) Small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, such as Direct Violet Colour Index (Society of Dyers and Colourists, Bradford, UK) numbers Direct Violet 9, Direct Violet 35, Direct Violet 48, Direct Violet 51, Direct Violet 66, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Violet 49, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159, Acid Violet 17, Acid Violet 43, Acid Red 73, Acid Red 88, Acid Red 150, Acid Blue 25, Acid Blue 29, Acid Blue 45, Acid Blue 113, Acid Black 1, Direct Blue 1, Direct Blue 71 and Direct Violet 51. (b) Polymeric dyes include polymeric dyes selected from the group consisting of polymers containing conjugated chromogens (dye-polymer conjugates) and polymers with chromogens co-polymerized into the backbone of the polymer and mixtures thereof such as fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® (Milliken, Spartanburg, S.C., USA) Violet Conn., carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC and mixtures thereof. (c) Dye clay conjugates include dye clay conjugates selected from the group comprising at least one cationic/basic dye and a smectite clay, and mixtures thereof. (d) Pigments such as Ultramarine Blue (C.I. Pigment Blue 29), Ultramarine Violet (C.I. Pigment Violet 15) and mixtures thereof.

In one aspect, the benefit agent may comprise a fabric softening active, a deposition agent, cationic polymer or cationic starch, or mixtures thereof, such as, for example, any of those described in US2008-0131695.

In one aspect, the benefit agent may comprise a chelating agent active, such as, for example, diethylene triamine pentamethylene phosphonic acid (“DTPMP”), hydroxy-ethane diphosphonic acid (“HEDP”), diethylene triamine pentaacetic acid (“DTPA”) and mixtures thereof.

In one aspect, the benefit agent delivery particle may have a particle size of from about 0.1 microns to about 1000 microns, from about 0.2 microns to about 200 microns, from about 0.5 microns to about 50 microns or about 0.5 to about 30 microns. The benefit agent delivery particle may be in the form of a microcapsule. In one aspect, the particles or microcapsules are sized such that they are not typically visible to a consumer when such microcapsules are incorporated into a cleaning composition. Without being bound by theory, it is believed that having a low particle size facilitates the liquid phase's ability to suspend the particles, thereby keeping the liquid phase as homogenous as possible.

In one aspect, the fabric care compositions may contain more than one benefit agent delivery particles, wherein the more than one benefit agent delivery particles have different release properties. In one aspect, the fabric care composition may comprise a first benefit agent delivery particle capable of releasing a benefit agent in less than about one minute, or about 2 minutes or 3 minutes, according to Test Method 1, and a second benefit agent capable of releasing a benefit agent after about 2 minutes or about 3 minutes or about 5 minutes according to Test Method 1. In one aspect, more than one benefit agents are supplied by the more than one benefit agent delivery particles. The benefit agent(s) may be present in the amount of from about 0.0001% to about 10%, from about 0.001% to about 4%, or from about 0.01% to about 2%, or from about 0.05% to about 1.5% by weight of the total fabric care composition.

In one aspect, the compositions may contain a benefit agent delivery particle, wherein the benefit agent delivery particle releases from about 50% to about 100%, or from about 60% to about 100%, or from about 70% to about 100%, or from about 80% to about 100%, or from about 90% to about 100% of the benefit agent within about 10 minutes, or within about five minutes, or within about two minutes, or within about one minute upon dilution in water as set out in Test Method 1. In one aspect, the benefit agent delivery particle releases from about 50% to about 100%, or from about 60% to about 100%, or from about 70% to about 100%, or from about 80% to about 100%, or from about 90% to about 100% of the benefit agent within about five minutes upon dilution in water as set out in Test Method 1.

In one aspect, the compositions may contain a benefit agent delivery particle, wherein the benefit agent delivery particle comprise from about 60% to about 100%, or from about 70% to about 100%, or from about 80% to about 100% or from about 90% to about 100% of the benefit agent after being stored at Warm Storage Conditions for 3 weeks (as set out in Test Method 2).

In one aspect, the composition may contain a benefit agent delivery particle, wherein the benefit agent delivery particle contains from about 0.5% to about 90%, or from about 1% to about 50%, or from about 2% to about 30%, or from about 5% to about 25%, or from about 10% to about 25% by dry weight of the benefit agent.

In one aspect, the disclosed compositions may have a viscosity of from about 3 cP to about 50,000 cP, or from about 10 cP to about 500 cP, or from about 15 cP to about 250 cP. The compositions may have a pH of from about 2 to about 8, from about 2 to about 6, or from about 2.5 to about 4.5. In one aspect, the compositions, absent the one or more benefit agent delivery particle, may have a specific density of from about 0.9 g/cm³ to about 1.3 g/cm³, from about 0.95 g/cm³ to about 1.2 g/cm³, or about 0.98 g/cm³ to about 1.1 g/cm³.

In one aspect, the compositions may be characterized by the difference between the specific density of the benefit agent delivery particle and the specific density of the composition absent the benefit agent delivery particle. In this aspect, the difference between the specific density of each type of benefit agent delivery particles and the specific density of the cleaning composition minus the one or more benefit agent delivery particles may be from about 0 g/cm³ to about 0.5 g/cm³, from 0 g/cm³ to about 0.2 g/cm³, from 0.00001 g/cm³ to about 0.05 g/cm³. The standard deviation for the density of each type of benefit agent delivery particles may be from about 0 to about 0.2, or from about 0.00001 to about 0.05.

### Adjunct Materials

In one aspect, the disclosed compositions contain a benefit agent delivery particle and one or more adjunct ingredients. The adjunct ingredient may comprise any of those described herein, or may comprise any other adjunct agent suitable for use in the desired composition. The adjuncts illustrated in the non-limiting list hereinafter are suitable for use in the instant compositions and may be incorporated in certain aspects, for example to assist or enhance performance, for treatment of the substrate to be conditioned, or to modify the aesthetics of the composition. Such adjuncts may be in addition to the benefit delivery particles described above. The precise nature of these additional components, and levels of incorporation thereof, will depend on the overall benefit profile the composition is intended to deliver. Suitable adjunct materials include fabric softening actives, suds suppressors, perfumes, pro-perfumes, encapsulated perfumes, perfume micro-capsules, dispersing agents, stabilizers, pH control agents, colorants, brighteners, dyes, odor control agent, cyclodextrin, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, soil suspension polymers, malodor control agents, fabric refreshing agents, chlorine bleach odor control agents, dye fixatives, dye transfer inhibitors, color maintenance agents, color restoration/rejuvenation agents, anti-fading agents, whiteness enhancers, hueing agents, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, thickeners, chelants, electrolytes and mixtures thereof.

Adjunct materials may be selected from the group comprising fabric softener actives, suds suppressors, soil release agents, soil suspension polymers, perfumes, pro-perfumes, perfume micro-capsules, malodor control agents, hueing agents and combinations thereof.

### Processes of Making Benefit Agent Delivery Particles and Compositions

Methods of making benefit agent delivery particles are also disclosed. In one aspect, the benefit agent delivery particles may be made using a spray drying process, comprising the steps of i) providing a cellulosic polymer and a benefit agent in a solvent to form a mixture, ii) introducing the mixture into a spray dryer for a period of time sufficient for the benefit agent delivery particles to form. The solvent may comprise an organic solvent, alkaline alcoholic solvent, alkaline aqueous solvent, aqueous solvent, or mixtures thereof. In one aspect, the solvent may comprise sodium bicarbonate. Mechanical action may be employed during the dissolving step. In one aspect, the cellulosic polymer may be dissolved in the solvent prior to the introduction of the benefit agent.

The compositions may be formulated into any suitable form and prepared by any process chosen by the formulator, for example as disclosed in WO99/29823 Demeyere et al., published Jun. 17, 1999 in the section entitled “Summary of invention”.

A method of imparting a benefit delivery capability to a fabric care composition comprising combining a particle comprising a benefit agent and a polymer selected from the group consisting of hydroxypropyl methylcellulose phthalate, cellulose acetate phthalate, and mixtures thereof with a fabric care composition is also disclosed. In one aspect, said benefit agent may be selected from the group consisting of enzymes, hueing dyes, metal catalysts, bleach catalysts, peracids, perfumes, biopolymers, and mixtures thereof. In one aspect, said particle is combined with at least one component of said fabric care composition and said combination of particle and at least one component of said cleaning and/or treatment composition is combined with other materials to form a cleaning and/or treatment composition.

### Method of Use

A method for treating fabric is also disclosed. In one aspect, such method includes the steps of washing a fabric, followed by rinsing the fabric in a rinse solution containing a composition disclosed herein. In another aspect, the washed fabrics may be rinsed once or several times in a separate rinse solution before being rinsed in the solution containing the composition disclosed herein.

In still another aspect, fabrics may be rinsed in a solution containing the composition without prior washing.

In one aspect, the final pH of the solution containing the composition used for the rinse step may be from about 5 to about 12, from about 6 to about 10, or from about 6.5 to about 9. The compositions may be used at concentrations of from about 50 ppm to about 20,000 ppm in solution, alternatively from about 100 ppm to 10,000 ppm. The water temperatures typically range from about 5° C. to about 30° C. The water to fabric ratio may be from about 1:2 to about 100:1. In one aspect, the composition may be supplied in a water soluble pouch, wherein the pouch may comprise polyvinyl alcohol.

### Test Methods

Viscosity is determined using a viscometer (Model AR2000, available from TA Instruments, New Castle, Del., USA), each sample is tested at a sample temperature of 25° C. using a 40 mm 2° steel cone at shear rates between 0.01 and 150 s⁻¹. Viscosities are expressed as units centipoise (cP) and are measured at a shear rate of 1 s⁻¹.

Average Particle Size is determined in accordance ASTM E1037-84 version 1, 2004. pH is assayed according to the standard method ES ISO 10523:2001 version 1.

Test Method 1—Benefit Agent Release from Benefit Agent Delivery Particle

0.05 g of benefit agent delivery particle is weighed and dispersed into 5 mL of the Fabric Care composition described in Example 7. 5 mL of the composition described in example 6 is added to 500 mL of water (having the composition described in Table 1) at 20° C. and the Fabric care composition containing the benefit delivery particle is then added to the mixture. The mixture is then stirred for 10 minutes at 150 RPM using a stirrer plate, IKAMAG RET basic, available from Scientific Lab.com.

The amount of benefit agent released after 1, 2, 5, and 10 minutes from the benefit agent delivery particle can be measured using standard analytical methods. Enzyme release may be measured using ASTM method D0348-89 (2003).

### Test Method 2—Determination of Benefit Agent Leakage and Stability on Storage

0.05 g benefit agent delivery particle is weighed and dispersed into 5 mL of the fabric care composition described in Example 7. The resulting mixture is then mixed for 2 minutes and sealed in a standard airtight 10 mL glass vial. This procedure is repeated, resulting in 20 multiple replicates. The 20 replicates are split equally into two batches. Ten replicates of Batch 1 are placed into a temperature controlled oven at 35° C. (Warm Storage Conditions) for a period of three weeks. Ten replicates of Batch 2 (Cold Storage Conditions) are placed into a refrigerator at 5° C. for a period of three weeks. The samples are removed from each of the two temperature controlled rooms after the three week period and analyzed for benefit agent content (note in the case of materials such as enzymes that can be inactivated, the resulting data is compared to analysis is versus the active content).

### Determining Benefit Agent Release and Leakage

Five replicates from each of Batch 1 and 2 (as described above) are individually diluted into 500 mL of water (having the composition described in Table 1) at 20° C.; 5 mL of the composition described in example 6 is added to the mixture. Each mixture is stirred for 10 minutes at 150 RPM using a stirrer plate, IKAMAG RET basic, available from ScientificLab.com. The mixtures are then analyzed using the protocol described in Test Method 1 to determine the total amount of benefit agent remaining after storage. This amount is expressed as A mg/mL of composition, where A is the value emerging from the test. Five replicates from each different batch are filtered through a 0.45 micron filter (available from Whatman Incorporated, NJ, USA) to remove the benefit agent delivery particles. Each filtered fluid sample is then individually diluted into 500 mL of water (having the composition described in Table 1) at 20° C. The diluted filtered fluid sample is then stirred for 10 minutes at 150 RPM using a stirrer plate, IKAMAG RET basic, available from Scientific Lab.com, and analyzed according to the protocol described in Test Method 1 to determine the amount of benefit agent that has leaked from the benefit agent delivery particle after storage. This amount is expressed as B mg/ml of composition, where B is the value emerging from the test.

The % benefit agent present after storage in the benefit agent particle (“X”) can be calculated using the following equation:

X=100(A−B)/C

wherein A and B are the values obtained as described above, and C is the amount of benefit agent expected to be present in the liquid detergent sample based on the activity of the added benefit agent delivery particle using standard analytical method such as those disclosed in Test Method 1.

### Example 1

### Synthesis of a Benefit Agent Delivery Particle Containing Amylase Enzyme Encapsulated in Hydroxypropylmethylcellulose Phthalate (HPMCP)

Two grams of HPMCP, grade 55 (Shin-Etsu, Chemical Co., Ltd, Tokyo 100-0004, Japan) is dissolved into 25 ml of alcoholic sodium hydroxide (0.52% weight/volume sodium hydroxide in methanol) is placed into a 100 mL conical flask and sonicated for 30 minutes. 5.2 g of Amylase liquid (available from Novozymes A/S having Amylase activity of 220KNU/mL) is added to the homogenous solution and stirred for 10 minutes at 150 RPM using a stirrer plate, IKAMAG RET basic (available from ScientificLab.com). This dispersion is fed into the spray dryer (available from Buchi, B-191, Switzerland) at a rate of 2.5 mL/minute, using a constant atomized air pressure of 2 kg/cm². The inlet and outlet temperatures are 40° C. and 30° C. respectively. The dispersion feedstock is continuously stirred at 150 RPM using a stirrer plate (IKAMAG RET basic, available from ScientificLab.com) while being fed into the spray dryer (Buchi, B-191, Switzerland). The benefit agent delivery particles formed in the spray dryer are collected into a receptor vessel via a cyclone. The benefit agent delivery particles are then weighed (1.62 g) and measured for particle size in the range of from about 2 to about 15 microns in accordance to ASTM E1037-84 method, version 1. The resulting benefit agent delivery particles are analyzed by SEM (TM-1000, Hitachi), Axio Microscope (Zeiss, Germany) and STEREO microscope (Zeiss, Germany). The benefit agent delivery particles are analyzed initially and after being stored for active enzyme content using Methods 1 and 2. The resultant enzyme microcapsules retain≧80% active enzyme content after being stored and have leakage of from about 0% to about 20% as measured in the stored samples using Test Method 2, above. The release from the microcapsules is ≧80% of the active enzyme after 5 minutes dissolution using Test Method 1.

### Example 2

### Synthesis of a Benefit Agent Delivery Particle Containing Protease Enzyme Encapsulated in Cellulose Acetate Phthalate (CAP)

Five grams of CAP powder (G.M. Chemie Pvt Ltd, Mumbai, 400 705, India) is dissolved into 95 mL of aqueous sodium bicarbonate (1.26% weight/volume). This solution is then transferred into a glass petri dish which is then placed into glass container containing liquid nitrogen for five minutes or until the mixture attains the temperature of the liquid nitrogen. The petri dish is then freeze dried using a lyophilizer (Alpha 1-2 LD, from Martin Christ, Gefriertrocknungsanlagen GmbH, D-37507 Osterode am Harz, Germany) for 9.5 hours at −54° C. The resulting freeze-dried, alkali-treated CAP product forms a film which is cut into small pieces and then used for making the microcapsules. 2 g of the freeze-dried, alkali-treated CAP is dissolved into 33 mL of methanol, and placed into a 100 mL conical flask and sonicated for 30 minutes. 0.81 g of Savinase® liquid (supplied by Novozymes A/S having Protease activity of 44 KNPU/g) is added to the homogenous solution and stirred for 10 minutes at 150 RPM using a stirrer plate (IKAMAG RET basic, supplied by ScientificLab.com). The dispersion feedstock is continuously stirred at 150 RPM using a stirrer plate (IKAMAG RET basic, available from ScientificLab.com) while being fed into the spray dryer (Buchi, B-191, Switzerland) at a rate of 2.5 mL/minute, using a constant atomized air pressure of 2 kg/cm². The inlet and outlet temperatures are 40° C. and 30° C. respectively. The benefit agent delivery particles formed in the spray dryer are collected into a receptor vessel via a cyclone. The benefit agent delivery particles are then weighed (1.23 g) and measured for particle size distribution of about 2-15 microns in accordance to ASTM E1037-84 method, version 1. The resulting benefit agent delivery particles are analyzed by SEM (TM-1000, Hitachi), Axio Microscope (Zeiss, Germany) and STEREO microscope (Zeiss, Germany). The benefit agent delivery particles are analyzed initially and after being stored for active enzyme content using Test Methods 1 and 2, described above.

### Example 3

### Synthesis of a Benefit Agent Delivery Particle Comprising Lipase Enzyme

The process of Example 1 is used, except the enzyme benefit agent is a lipase enzyme as described above.

### Example 4

### Synthesis of a Benefit Agent Delivery Particle Comprising a Hueing Dye

The process of Example 1 is used, except the enzyme benefit agent is a hueing dye as described above.

### Example 5

### Synthesis of a benefit agent delivery particle comprising 20 wt % Core/80 wt % HPMCP coated Dichloro-1,4-diethyl-1,4,8,11-tetraaazabicyclo [6.6.2]hexadecane manganese(II)

A 10% solution of HPMCP, grade 50 (“HP 50”) (available from SEPPIC SA, 7 Boulevard Franck Kupka, 92039 Paris La Defense, Cedex, France) in a 5% sodium bicarbonate aqueous solution is prepared at 50° C. and filtered with a 1.2 micron filter (Albet, Dassel, Germany). The solution is cooled to room temperature. Two grams of dichloro-1,4-diethyl-1,4,8,11-tetraaazabicyclo[6.6.2] hexadecane manganese(II) are added to 98 g of the HP 50 solution previously prepared and mixed (IKA RW-16-Basic, available from IKA-Werke GmbH & Co. KG, Janke & Kunkel Str. 10, 79219 Staufen, Germany) until the dichloro-1,4-diethyl-1,4,8,11-tetraaazabicyclo[6.6.2] hexadecane manganese(II) is completely dissolved. A spray-dryer is used to collect the particles (4M8 Spray-Dryer from ProCepT, Belgium). Parameters used in the spray-drying process are as follows: nozzle 0 4 mm; schuin 60 cyclone; temperature inlet air 140° C.; air flow 0.4 m³/min; feeding speed 2 mL/min with syringe. A yield of 58.14% is obtained. Particles are than collected and analyzed by SEM (TM-1000, Hitachi).

TABLE 1
Water Composition

| | |
|---|---|
| Total water hardness (Mg/L) | 165 |
| Calcium : Magnesium ratio | 3:1 |
| pH | 7.7 |
| Volume de-ionized water (L) | 1 |
| Magnesium chloride hexahydrate (Mg/L) | 50 |
| Calcium chloride dihydrate (Mg/L) | 115 |
| Sodium bicarbonate (Mg/L) | 85 |

TABLE 2
Example 6: Detergent composition.

| Ingredient | Wt% |
|---|---|
| C₁₂₋₁₅ alkylethoxy(1.8) sulfate | 17.5 |
| C₁₆₋₁₇ branched alkyl sulfate | 2.1 |
| C₁₂₋₁₄ alkyl-9-ethoxylate | 0.8 |
| C₁₂ dimethylamine oxide | — |
| citric acid | 3.8 |
| amine oxide | 0.72 |
| C₁₂₋₁₈ fatty acid | 1.8 |
| calcium formate | 0.1 |
| benefit agent delivery particle* | — |
| A compound having the following general structure: | |
| his ((C₂H₅O)(C₂H₄O)n)(CH₃)—N⁺—C_{X}H_{2X}—N⁺—(CH3)— | |
| bis ((C₂H₅O)(C₂H₄O)n), wherein n = from 20 to 30, | |
| and x = from 3 to 8, | |
| or sulphated or sulphonated variants thereof | 1.3 |
| diethylene triamine pentaacetic acid | 0.4 |
| ethanol | 2.4 |
| propylene glycol | 3.6 |
| diethylene glycol | 1.3 |
| polyethylene glycol | 0.1 |
| Monoethanolamine | 1.8 |
| NaOH | to pH 8.3 |
| dye | 0.01 |
| Water and optional minors (antifoam, aesthetics) | To 100% |

TABLE 3
Examples 7-14: Fabric Care compositions.
Examples
Ingredients shown as % wt of total composition

| INGREDIENT | 7 | 8 | 9 | 10 | 11 | 12 | 13 | 14 |
|---|---|---|---|---|---|---|---|---|
| Fabric softening | 12.25 | 12.25 | 5 | | | 7.44 | 8.9 | 5 |
| active^{a} | | | | | | | | |
| Fabric softening | | | | | 10 | | | |
| active^{b} | | | | | | | | |
| Antifoam^{c} | | | | 0.2 | | | | 0.2 |
| Silicone comprising | | | | | | 3.0 | 3.0 | |
| compound^{d} | | | | | | | | |
| CAE10^{e} | | | | | | 0.33 | 0.22 | |
| MPG^{f} | | | | | | 5.00 | 1.81 | |
| Glycerol | | | | | | 5.00 | 0.77 | |
| Perfume | 0.9 | 0.6 | 0.4 | 0.5% | 0.6 | 0.60 | 0.60 | 0.5 |
| Perfume | | 0.3 | | | | 0.25 | 0.25 | |
| microcapsule | | | | | | | | |
| Preservative | 0.005 | 0.005 | 0.0075 | 0.0075 | 0.0075 | 0.0075 | 0.0075 | 0.0075 |
| Structurant | | 0.15 | | 0.3% | | 0.2 | 0.2 | 0.3 |
| Calcium chloride | 0.025 | 0.025 | | | 0.025% | 0.05 | 0.05 | |
| Vitasyn Blue Dye | 0.0005 | 0.0005 | 0.00025 | 0.00025 | 0.0005 | 0.00028 | 0.00028 | 0.00025 |
| Sanolin Violet Dye | | | 0.0005 | 0.0005 | | 0.00052 | 0.00052 | 0.0005 |
| Hydrochloric acid | 0.02 | 0.005 | 0.015 | 0.01 | 0.015 | | | 0.01 |
| Formic acid | | 0.025 | | | | 0.025 | 0.025 | |
| Deionized water | Balance | Balance | Balance | Balance | Balance | Balance | Balance | Balance |

^{a}N,N-di(tallowoyloxyethyl)-N,N-dimethylammonium chloride
^{b}TEA esterquat, available from Evonik under the trade name Rewoquat WE 18
^{c}Silfoam SE 90 available from Wacker
^{d}Silicone comprising compound, available under the trade name SM2169 supplied by Momentive
^{e}Non ionic surfactant-C12/14 Alcohol Ethoxylate
^{f}Mono-propylene glycol
*Refers to benefit agent delivery particle made according to Examples 1 to 5 herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.
While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric care composition comprising:
a. a benefit agent delivery particle comprising a benefit agent and a cellulosic polymer selected from the group consisting of hydroxypropyl methylcellulose phthalate, cellulose acetate phthalate, and mixtures thereof; and
b. one or more adjunct materials selected from the group comprising fabric softener actives, suds suppressors, soil release agents, soil suspension polymers, perfumes, pro-perfumes, perfume micro-capsules, malodor control agents, hueing agents and combinations thereof.

2. The fabric care composition of claim 1 wherein the benefit agent comprises a material selected from the group consisting of enzymes, hueing dyes, metal catalysts, perfumes, pro-perfumes, biopolymers, antimicrobial agents, malodour protection agents, and mixtures thereof.

3. The fabric care composition of claim 1 wherein the benefit agent comprises an enzyme.

4. The fabric care composition of claim 4 wherein said enzyme is selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

5. The fabric care composition of claim 3 wherein the composition comprises an enzyme stabilizer component selected from the group consisting of:
a. inorganic salts selected from the group consisting of calcium salts, magnesium salts and mixtures thereof;
b. carbohydrates selected from the group consisting of oligosaccharides, polysaccharides and mixtures thereof;
c. mass efficient reversible protease inhibitors selected from the group consisting of phenyl boronic acid and derivatives thereof; and
d. mixtures thereof.

6. The fabric care composition of claim 1 wherein the benefit agent comprises a hueing dye.

7. The composition according to claim 1 wherein the benefit agent comprises a deposition agent, cationic polymer or cationic starch, or mixtures thereof.

8. The fabric care composition of claim 1 wherein the benefit agent delivery particle has a particle size of from about 0.1 microns to about 1000 microns.

9. The fabric care composition of claim 1 wherein the benefit agent supplied by the benefit agent delivery particles is from about 0.0001 wt % to about 10 wt % of the composition.

10. The fabric care composition of claim 1, wherein from about 50% to about 100% of the benefit agent is released from the benefit agent delivery particles within about ten minutes upon dilution in water as set out in Test Method 1.

11. The fabric care composition of claim 1, wherein from about 60% to about 100% of the benefit agent is present within the benefit agent delivery particle after three weeks at Warm Storage conditions as described in Test Method 2.

12. The fabric care composition of claim 1, wherein the composition comprises more than one benefit agent delivery particle, wherein the more than one benefit agent delivery particles have different release properties.

13. The fabric care composition of claim 1 wherein the difference between the specific density of the benefit agent delivery particles and the specific density of the cleaning composition in the absence of the benefit agent delivery particles is from about 0 g/cm³ to about 0.5 g/cm³.

14. The fabric care composition of claim 1, wherein, the benefit agent delivery particle comprises from about 0.5% to about 90% benefit agent based on total dry benefit agent delivery particle weight.

15. A method of imparting a benefit delivery capability to a fabric care composition comprising combining a particle comprising a benefit agent and a polymer selected from the group consisting of hydroxypropyl methylcellulose phthalate, cellulose acetate phthalate, and mixtures thereof with the fabric care composition.
